(19) United States
(12) Patent Application Publication
(10) Pub. No.: US 2018/0328900 A1
(43) Pub. Date: Nov. 15, 2018

(54) OPEN TUBULAR LIQUID CHROMATOGRAPHY APPARATUS AND METHODS OF USE

(71) Applicant: The Board of Regents of the University of Oklahoma, Norman, OK (US)

(72) Inventor: Shaorong Liu, Norman, OK (US)

(21) Appl. No.: 15/977,525

(22) Filed: May 11, 2018

Related U.S. Application Data
(60) Provisional application No. 62/504,933, filed on May 11, 2017.

(51) Int. Cl. G01N 30/60; B05D 7/22; B01D 11/04

(52) U.S. Cl. CPC G01N 30/6073; B01D 11/04; B05D 7/222

(57) ABSTRACT

An open tubular chromatography apparatus has at least one liquid chromatography capillary, a valve in fluid communication with the liquid chromatography capillary for adding a sample to the liquid chromatography capillary, an injector in fluid communication with the valve for driving liquid eluent through the liquid chromatography capillary whereby components of the sample are separated in the eluent, and one or more detectors for detecting the components in the sample as the components elute from the liquid chromatography capillary. The liquid chromatography capillary has an inner surface and an inner diameter in a range of from about 1 μm to about 5 μm. The inner surface is coated with a stationary phase film.

### CROSS-REFERENCE TO RELATED APPLICATIONS

This application claims priority to U.S. Provisional Application Ser. No. 62/504,933, filed on May 11, 2017, which is expressly incorporated herein by reference in its entirety.

### BACKGROUND

Open tubular liquid chromatography (OTLC) is an analytical tool for separation of sample components. Open tubular (OT) columns were first used in gas chromatography (GC) in 1958. The OT columns quickly replace packed columns used in GC for most analytical applications because of the increased efficiencies under similar analysis times and inlet pressures. The optimal column diameters for open tubular gas chromatography (OTGC) have usually been a few hundred micrometers. The progress of OTLC was relatively slow compared to OTGC because there have been difficulties in using narrow columns. OTLC and open capillary electrokinetic chromatography (OTEC) have not been exploited using columns having an inner diameter less than 5 μm due to intrinsic challenges such as picoliter-volume detection, nano-capillary column preparation, and low sample loading capacity utilizing such narrow capillaries. To increase the loading capacity, researchers have experimented with etching/roughing the column interior wall surface, but the most successful approach has been attaching a porous layer to the wall surface to create a porous layer open tubular (PLOT) column. PLOT column LC has now been applied in proteomic research. However, due to the thick-layer stationary phase, mass transfer inside the stationary phase is retarded, leading to reduced efficiencies. In addition, reproducibly of PLOT columns (with the same polymer thickness and morphology) is challenging. It is to these problems that the apparatus and methods of the present disclosure are directed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a schematic view of an open tube liquid chromatography apparatus constructed in accordance with the inventive concepts disclosed herein.

FIG. 2 is a perspective view of a liquid chromatography capillary used in the open tube liquid chromatography apparatus shown in FIG. 1.

FIG. 3 is a sectional view of the liquid chromatography capillary tube in FIG. 2 showing a film coating the inner surface of the capillary.

FIG. 4 is a diagram of a valve embodiment for use with the open tube liquid chromatography apparatus.

FIG. 5A is a comparison of amino acid separations under different elution pressures.

FIG. 5B is a graph of plate height as a function of mobile phase velocity.

FIG. 6A is a separation chromatogram using a 2 μm i.d. capillary tube.

FIG. 6B is a separation chromatogram using a 5 μm i.d. capillary tube.

FIG. 7 is a series of is chromatograms illustrating the effect of column length on resolution.

FIG. 8A is a chromatogram showing results of gradient elution in Example 1.

FIG. 8B is a chromatogram showing results of isocratic elution in Example 1.

FIG. 9 is a series of chromatograms comparing different pressures for separation of amino acids.

FIG. 10 is a graph of efficiency versus pressure for separation of amino acids.

FIG. 11 is a series of chromatograms illustrating the effect of gradient profile on resolution for separation of trysin-digested protein.

FIG. 12 is a series of chromatograms illustrating the effect of separation pressure.

FIG. 13 is a series of chromatograms illustrating separation of a BSA trypsin digest, a Myoglobin trypsin digest, and a mixture of both.

FIG. 14 is a chromatogram illustrating separation of an E. coli tryptic digest.

### DETAILED DESCRIPTION

As noted above, OTLC and OTEC have never utilized nanocapillary columns having very narrow inner diameters (e.g., 1-5 μm) due to the challenges such narrow capillaries present. Prior to the present disclosure, it was unknown if the theoretically predicted efficiencies were practically achievable. Here it is shown that not only can the predicted efficiencies be achieved, but also efficiencies with orders of magnitude greater than the predicted numbers. For example, plate heights of less than 0.1 μm have been obtained in less than 10 min and under an elution pressure of about 300 pounds per square inch (psi) or about 20 bar. Such high-resolution and fast separation capability will have a major impact on proteomic research, since analytical tools with limited resolution and limited speed have been a bottleneck for analyzing complex proteomic samples using conventional methods.

Before further describing various embodiments of the present disclosure in more detail by way of exemplary description, examples, and results, it is to be understood that the embodiments of the present disclosure are not limited in application to the details as set forth in the following description. The embodiments of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. The embodiments of and application and use thereof can be made and executed without undue experimentation in light of the present disclosure. While the present disclosure has been described in terms of particular embodiments, it will be apparent to those of skill in the art that variations may be applied to the apparatus and/or methods and in the steps or in the sequence of steps of the methods described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the apparatus, methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the terms “at least one” or “plurality” will be understood to include one as well as any quantity more than one, including but not limited to, 2, 3, 4, 5, 6, 7, 8, 9, 10, 15, 20, 30, 40, 50, 100, or any integer inclusive therein, and/or any range described herein. The terms “at least one” or “plurality” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the term “about” is used to indicate that a value includes the inherent variation of error for the composition, the method used to administer the composition, or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The term “about” or “approximately”, where used herein when referring to a measurable value such as an amount, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 2-18 therefore includes 2, 3, 4, 5, 6, 7, 8, 9, 10, 11, 12, 13, 14, 15, 16, 17, and 18. Reference to a range of 1-30 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, as well as sub-ranges within the greater range, e.g., for 1-30, sub-ranges include but are not limited to 1-10, 2-15, 2-25, 3-30, 10-20, and 20-30. Reference to a range of 1-50 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, etc., up to and including 50. Reference to a series of ranges includes ranges which combine the values of the boundaries of different ranges within the series. Thus, to illustrate reference to a series of ranges, for example, a range of 1-1,000 includes, but is not limited to, 1-10, 2-15, 2-25, 3-30, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 3 mm to 25 cm therefore refers to and includes all values or ranges of values, and fractions of the values and integers within said range, including for example, but not limited to, 4 mm to 22.5 cm, 4 mm to 20 cm, 6 mm to 22 cm, 6 mm to 20 cm, 10 mm to 17 cm, 7.5 nm to 20 cm, 7.5 mm to 10 cm, 5 mm to 16 mm, 4 mm to 20 mm, and 8 mm to 12 cm. Any two values within the range of 3 mm to 25 cm therefore can be used to set the lower and upper boundaries of a range in accordance with the embodiments of the present disclosure.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

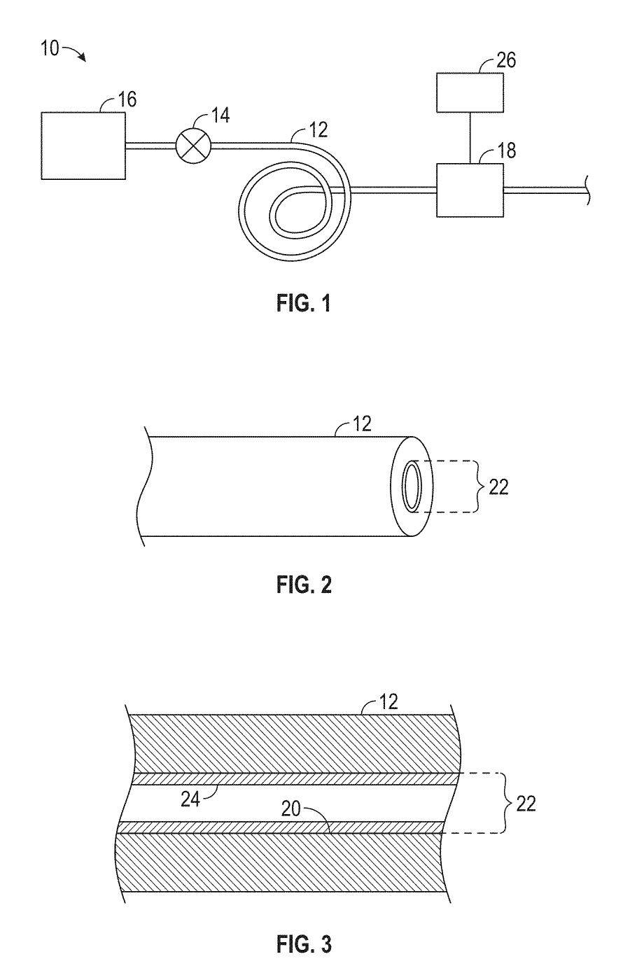

Turning now to the presently disclosed inventive concept(s) and to FIGS. 1-3, an open tubular liquid chromatography apparatus 10 constructed in accordance with the inventive concepts disclosed herein is illustrated. The open tubular liquid chromatography apparatus 10 has a liquid chromatography capillary 12, a valve 14 in fluid communication with the liquid chromatography capillary 12 for adding a sample to the liquid chromatography capillary 12, an injector 16 in fluid communication with the valve 14 for driving liquid eluent through the liquid chromatography capillary 12 whereby components of the sample are separated in the eluent, and one or more detectors 18 for detecting the components in the sample as the components elute from the liquid chromatography capillary 12. The liquid chromatography capillary 12 has an inner surface 20 and an inner diameter 22 in a range of from about 1 μm to about 5 μm. The inner surface 20 is coated with a stationary phase film 24.

The liquid chromatography capillary 12 generally has an inner diameter 22 between about 1 μm and about 5 μm. The inner diameter 22 is measured from one solid inner side wall to the opposing solid inner side wall (i.e., the thickness of the stationary phase film 24 is not considered and does not affect the inner diameter 22).

In one embodiment, the inner diameter 22 is in a range of from about 1 μm to about 3 μm. In another embodiment, the inner diameter 22 is in a range of from about 1 μm to about 2 μm. The outside diameter of the liquid chromatography capillary 12 is not critical, but typically ranges from about 90 μm to about 360 μm or greater.

Reducing the capillary inner diameter 22 is essential to increasing separation efficiencies. However, open tube liquid chromatography applications such as high-performance liquid chromatography (HPLC) have not used a capillary of i.d. of 5 μm or less, apparently due to experimental limitations such as low sensitivity and difficulties in the preparation of a retentive layer (i.e., coating or film) on the capillary inner surface. A 2 μm i.d. capillary column is close to the dimension of a single pathway in a conventional packed column. Because of the small bore, only chemical modification on the inner wall of the capillary can provide a high ratio of stationary phase to mobile phase, leading to high retentive ability. However, preparation of retentive layer via polymerization in small-bore capillaries have previously resulted in clogging issues.

Fast liquid component separations can be achieved with high separation efficiencies using capillaries with a small inner diameter (i.d.). As further discussed in the Examples below, experimentally measured efficiencies using an embodiment of the presently disclosed open tubular liquid chromatography apparatus 10 were 1.5 to 20 times greater than those theoretically predicted.

In one embodiment, the open tubular liquid chromatography apparatus 10 can achieve separation efficiencies greater than 10⁶ plates/m. In another embodiment, the open tubular liquid chromatography apparatus 10 can achieve separation efficiencies greater than 10⁷ plates/m.

The liquid chromatography capillary 12 can be made of suitable materials known to those skilled in the art including, but not limited to, stainless steel, glass, fused silica, polymer, and combinations thereof. In one embodiment, the liquid chromatography capillary 12 comprises fused silica in a polymer coating or sleeve. The external polymer coating is applied to protect the silica outer surface from abrasion. Examples of suitable polymer coatings/sleeves include, but are not limited to polyimides, polyether ether ketone (PEEK), and the like. Polyimide-coated flexible fused silica capillaries are commercially available from, for example, Polymicro Technologies (Phoenix, Ariz.). Polyether ether ketone (PEEK) is a commercially available high pressure sleeve commonly used for HPLC applications. PEEK is also used for unions and other connections in fused silica tubing. The outside diameter typically ranges from 90 μm to 360 μm. In most applications, the coating thickness will depend upon the material and application.

When drawn, the internal surfaces of fused silica capillaries are fully dehydrated. To uniformly hydrate the inner surface 20 of the liquid chromatography capillary 12, in one embodiment filtered 1M NaOH is injected through the capillary at a temperature of 100° C. The capillary is then flushed with distilled water followed by flushing acetonitrile. The capillary 12 is then purged with nitrogen gas. This treatment prepares the fused silica for reaction with surface modification reagents to form the stationary phase film 24.

In one embodiment, the stationary phase film 24 comprises alkyl-containing molecules chemically grafted to the inner surface 20 of the liquid chromatography capillary 12. As used herein, “grafting” refers to covalent bonding of polymer chains onto a surface and includes initially both “grafting onto” mechanisms whereby a polymer chain adsorbs onto the surface out of solution and the “grafting from” mechanisms wherein a polymer chain is initiated and propagated at the surface.

Suitable materials for the stationary phase film 24 include, but are not limited to, organic compounds having straight or branched chains of 2-18 carbons (e.g., 18, 8, 4, and/or 2 carbon atoms), vinyl benzene derivatives, silanes, polysiloxanes, polyethylene glycols, affinity ligands/tags, ionic liquids, nanoparticles, organic compounds containing amine groups, carboxylic acid groups or sulfate groups, and the like. In one embodiment, the stationary phase film 24 comprises carbon chains having 2-18 carbons in the chain. In another embodiment, the stationary phase film 24 comprises single or mixed organic compounds such as organosilanes, polyvinyl benzenes, polystyrenes, silazanes, and the like. Non-limiting examples of other coating materials which can be used include those disclosed in U.S. Pat. No. 5,869,152, which is hereby expressly incorporated herein by reference in its entirety.

In one non-limiting embodiment, the stationary phase film 24 comprises an organosilane. For example, trimethoxy(octadecyl) silane reagent can be mixed in equal amounts with toluene and injected into the capillary 12 using a high-pressure chamber in an oven heated to about 50° C. Nitrogen gas at 500 psi can then be used to flush the capillary. The flushed capillary is washed with pre-heated toluene followed by drying with nitrogen gas. The capillary is thus coated on the inner surface with a stationary phase film 24 comprising trimethoxy(octadecyl) silane. As discussed in the Examples, the separations of amino acids and peptides using this column result in a high resolution, fast separation and high separation efficiency.

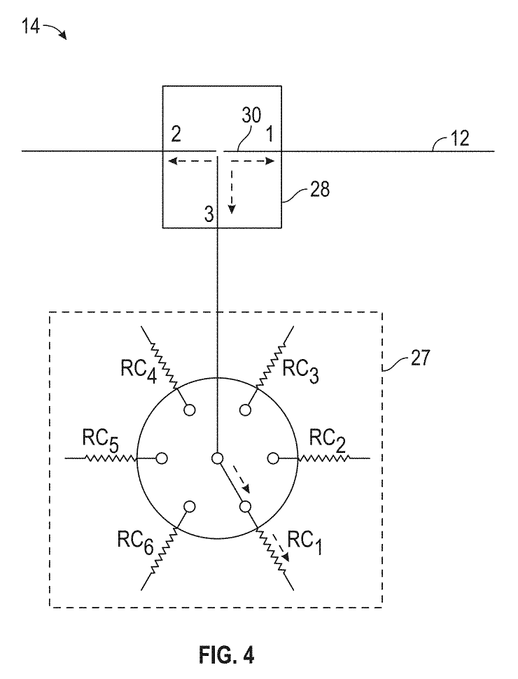

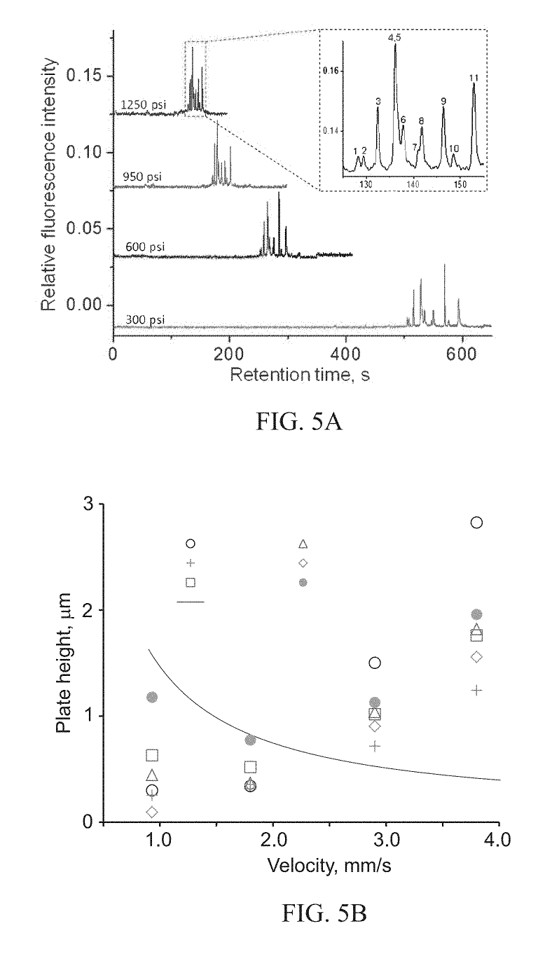

Referring now to FIG. 4, the valve 14 allows for injection of sample and eluent. In one embodiment, the valve 14 comprises a six-way injection valve 27 such as those available commercially from VICI in Houston, Tex. These valves allow injection of a low-pressure sample into a high-pressure mobile phase.

In one embodiment, the valve 14 comprises a microchip 28 having channels 30 wherein a portion of the liquid chromatography capillary 12 is disposed in a channel in the microchip 28.

In another embodiment, the valve 14 comprises both the 6-way injection valve and the microchip 28. Because pL-to-fL injection valves are not commonly available, in one embodiment an nL-size (e.g., a 60 nL-size) injection valve is used in conjunction with a microfabricated microchip 28 flow-splitter to implement the pL-to-fL sample injections. As the eluent is driven through the nL-size injection valve to the microfabricated microchip 28, it can be split into two streams: one stream going to the capillary column 12 and the other stream going through a restriction capillary to a waste reservoir. Since the flow resistance through the narrow chromatography capillary 12 is fixed, a specific flow splitting ratio can be determined by selecting a specific restriction capillary.

There are several ways to achieve the flow of sample and eluent through the liquid chromatography capillary 12. As understood by those skilled in the art, the injector 16 can drive the liquid eluent by electroosmotic flow or by mechanical means, such as a pressure pump, a gradient pump, or an electrical pump. Non-limiting examples of suitable mechanical injectors 16 include a syringe-type pump, a small piston reciprocating pump, a standard HPLC pump with a flow splitter, and a pressure chamber.

Once sample components are separated, the eluted components can be analyzed and identified using a number of possible detectors known to those skilled in the art and detectors yet to be developed. For example, the detector 18 can be a laser-induced fluorescence detector or a mass spectrometer. In one embodiment, multiple detectors 18 can be used. Because of the small sample size, multiple detectors would likely be used in series; however, it is possible to split the sample-containing eluent and analyze with two or more detectors in parallel. Typically, results from the detector 18 are recorded for future reference and analysis on a recording device 26, as shown in FIG. 1.

High efficiencies (e.g., greater than 10⁷ plates per meter) can be obtained when using a 2-μm-i.d. capillary to perform OTLC. The number of plates can be orders of magnitude higher than the theory-predicted values. The feasibility of the method for separating complex peptide samples has been demonstrated. The separations can usually be completed in less than 15 min on an experimental apparatus with an elution pressure of several hundred psi.

The inventive concepts of the present disclosure will be more readily understood by reference to the following examples and embodiments, which are included merely for purposes of illustration of certain aspects and embodiments thereof, and are not intended to be limitations of the disclosure in any way whatsoever. Those skilled in the art will promptly recognize appropriate variations of the apparatus, compositions, components, procedures and method shown below.

### Example 1

To demonstrate the feasibility of the approach of the present disclosure, an open tubular chromatography apparatus was used to perform OTLC using capillary columns of various i.d. (e.g., 2-μm-i.d. capillary). The column, or capillary, was coated with trimethoxy(octadecyl)silane. An Agilent 1200 HPLC pump coupled with a flow splitter served as a gradient pump. A 6-port valve was used for sample injection.

A laser-induced fluorescence (LIF) detector was employed to monitor the separation process. The excitation laser source emitted a 488-nm laser beam produced by an argon ion laser (LaserPhysics, Salt Lake City, Utah), directed by a dichroic mirror (Q505LP, Chroma Technology, Rockingham Vt.) and focused onto the detection window of the capillary column via an objective lens (20× and 0.5 NA, Rolyn Optics, Covina, Calif.). The emitted fluorescence was collimated by the same lens, went through the dichroic mirror, an interference band-pass filter (532 nm, Carlsbad, Calif.) and a 1 mm pinhole, and was finally collected by a photosensor module (H5784-04, Hamamatsu). A Measurement Computing USB-1208FS (Measurement Computing, Norton, Mass.) was used to measure the output of the photosensor module. The data were acquired and analyzed using a program written in-laboratory with LabVIEW (National Instruments, Austin, Tex.). The alignment of the detection window with the LIF detector 24 was achieved via an x-y-z translation stage.

A 150 μm o.d. capillary having a 2 μm i.d. was prepared using the following procedure:

A 40-μl 1M filtered NaOH solution was prepared in a 250-μl vial and the vial was placed in a high-pressure chamber, covered with septa and sealed with screwed cap. An 80-cm long, 2-μm i.d. and 150-μm o.d. capillary was cut. The coating was removed from the front tip of the capillary for about 1 cm length. A BD PRECISIONGLIDE™ 25 G×⅞″ HYPODERMIC needle was used as a sheath to guide the capillary to the above NaOH solution in the high-pressure chamber. The other end of the capillary tip was dipped into a 0.5-ml clean sealed vial with DDI water. Nitrogen gas @ 500 psi was applied via another needle into the high-pressure chamber to make sure the solution fill the capillary. The high-pressure chamber, the capillary and the vial for waste were moved into an oven at 100° C. NaOH solution was kept flowing through the capillary for 2 h.

The capillary tip was then pulled out of the NaOH vial, and the NaOH vial was replaced with a vial containing warm DDI water. The high-pressure chamber was capped, and the same needle was used to insert the capillary into the vial with warm DDI water. Nitrogen gas was applied at 500 psi to rinse the capillary with DDI water for 30 min. The high-pressure chamber, capillary and waste container were moved out of the oven. The same set up was used to rinse the capillary with acetonitrile for 15 min, followed by drying with 500 psi nitrogen gas overnight.

The glove box was purged with nitrogen gas three times to make sure it provided a water-free environment. Using the glove box, 50 μl trimethoxy(octadecyl) silane reagent from Sigma-Aldrich were mixed with 50 ul toluene in a 250-μl vial. The vial was placed into a high-pressure chamber and sealed. A needle was used to escort the front tip of the capillary to the mixed reagent solution in the high-pressure chamber. The other end of the capillary was dipped into a 0.5-ml clean sealed vial with toluene. The high-pressure chamber, capillary, and waste container were moved into the oven which had been preset at 50° C. 500 psi nitrogen gas was used to flush the capillary for 16 h. The capillary was then washed with pre-heated toluene for 1 h, followed by drying with nitrogen gas for 2 h. At this point the capillary was ready for use.

Sample Preparation

Amino acids and peptides were fluorescence tag-labeled according to the instruction of ATTO-TAG™ FQ Amine-Derivatization Kit. Briefly, 5.0 mg of ATTO-TAG FQ was dissolved in 2.0 mL of methanol to make a 10 mM stock solution. A 0.20 M KCN stock solution was prepared by dissolving 20 mg of KCN in 1.5 mL of ultrapure water. Working KCN solution (10 mM) was prepared just before use. Amino acid stock solutions (each containing 1 mM of one amino acid) were prepared in ultrapure water. A volume of 1.0 μL of the amino acid stock solution was mixed with 4.0 μL of 10 mM pH 9.2 Borax solution, 10 μL of the 10 mM KCN working solution, and 5 μL of the 10 mM FQ solution in a vial, and this mixture was maintained at room temperature under light protection for 1 h before use. The resulting FQ-labeled-amino acid was diluted with ultrapure water prior to analysis. A tryptic digest of BSA protein or myoglobin was used for peptides labeling. The digestion of BSA was performed as follows: 52 μL of filtered 10 mg/ml BSA was mixed with 10 μL of Trypsin solution, 20 of μL filtered 500 mM NH₄HCO₃, 1 μL 1 M DTT, and 117 μL ultrapure water. The mixture was kept at 37° C. for 8 hours before labeling. 5 μL of digestion mixture mixed with 10 μL of 10 mM KCN working solution, and 5 μL of the 10 mM FQ solution in a vial was maintained at room temperature under light protection for 1 h prior to analysis.

Results

FIG. 5A presents four isocratic separation chromatograms for eleven fluorescently labeled amino acids (labeled as above) under different elution pressures. All eleven peaks (except for peaks 4 and 5 in the top chromatogram) were resolved with resolutions (=Δt/(w_{1/2}+w′_{1/2}, where w_{1/2} and w′_{1/2} are the widths of two peaks and Δt is the distance between the two peaks) greater than 0.6. The separation was completed in less than 10 min under an elution pressure of 300 psi, while the separation was completed in less than 3 min under an elution pressure of 1,250 psi. The majority of the peaks had widths (peak-width at half-maximum) of less than 1 s.

FIG. 5B presents plate height as a function of mobile phase velocity. The data points were obtained from the column length (45 cm) divided by the number of theoretical plates of each peak. The solid-line was calculated based on Equation I (Golay equation):

$$H = \frac{2 {D}_{m}}{u} + \frac{{d}_{c}^{2} u ( 1 + 6 {k}^{′} + 11 {k}^{{′}^{2}} )}{96 {{D}_{m} ( 1 + {k}^{′} )}^{2}} + \frac{{d}_{f}^{2} u 2 {k}^{′}}{3 {{D}_{s} ( 1 + {k}^{′} )}^{2}} \qquad ( I )$$

where H is the plate height, u is the mobile phase velocity, k′ is the capacity factor of the solute, Dₘ and Dₛ are diffusion coefficients of the solute in the mobile and stationary phase respectively, d_{f} is the layer thickness of the stationary phase, d_{c} is the diameter of the channel available for the mobile phase (equal to the i.d. of the capillary minus 2d_{f}). Since the value of d_{f} in this work is small, we can neglect the last item in the equation and replace the d_{c} with d—the diameter of the open tubular column. As seen, many data points had plate heights of less than 1 μm. Peak 9 at u=0.93 mm/s had a plate height of 0.094 μm—corresponding to 1.1×10⁷ plates/m and 2.0×10⁴ plates/s. It is also important to notice that all the data points at low velocity (<1.5 mm/s) are below the theoretically calculated line.

Table 1 below presents a comparison between the theoretically-predicted and the experimentally-obtained efficiencies. The experimentally-obtained efficiencies are often higher than the theoretically-predicted values. Without wishing to be bound by theory, it is believed that the reduced diffusion coefficients of the analytes confined in a narrow capillary contributed partially to efficiency enhancement.

TABLE 1
Comparison between theoretically calculated
and experimentally obtained efficiencies

| Peak | Efficiency- | Efficiency- | |
|---|---|---|---|
| No. | measured | predicted | Ratio |
| 1 | 3.3 × 10⁶ | 5.6 × 10⁵ | 5.9 |
| 2 | 2.3 × 10⁶ | 5.0 × 10⁵ | 4.6 |
| 3 | 3.9 × 10⁶ | 4.0 × 10⁵ | 9.8 |
| 9 | 1.1 × 10⁷ | 5.5 × 10⁵ | 20 |
| 10 | 1.6 × 10⁶ | 5.8 × 10⁵ | 2.5 |
| 11 | 8.5 × 10⁵ | 5.6 × 10⁵ | 1.5 |

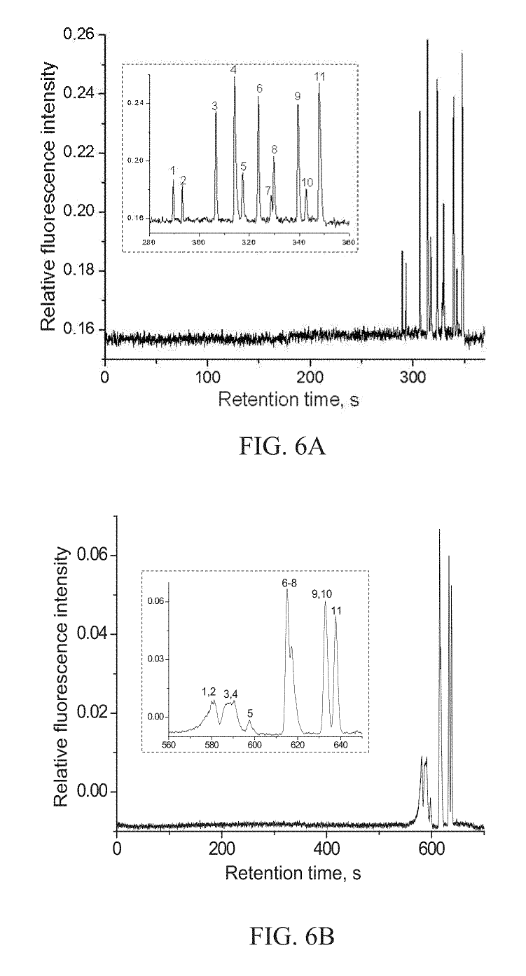

A performance comparison between a 2-μm-i.d. column and a 5-μm-i.d. column is shown in FIGS. 6A and 6B. The top graph, FIG. 6A, shows results using the 2-μm-i.d. column. All peaks were baseline resolved, except that peaks 7 and 8 were partially resolved. The lower graph, FIG. 6B, shows results using a 5-μm-i.d. column. Most peaks (peaks 1 and 2, peaks 3 and 4, peaks 6, 7 and 8, and peaks 9 and 10) were unresolved. A 10-μm-i.d. and a 1-μm-i.d. column were also tested (data not shown), and neither provided an efficient separation under these conditions. Without wishing to be bound by theory, it is believed that the low efficiencies of the 1-μm-i.d. column were due to inadequate or poor coating of the interior surface of the capillary.

Both the 5-μm-i.d. and 2-μm-i.d. columns had a total length of 48 cm (44 cm effective), and 150-μm o.d. Gradient profile was mobile phase B increased from 0% to 50% from 0 to 1.5 min, stayed at 50% B from 1.5 min to 2 min, and then decreased from 50% to 0% from 2 min to 2.5 min. For separation using the 2-um-i.d. column, the elution pressure was 600 psi and concentration of each amino acid was 6.5 μM. For separation using the 5-um-i.d. column, the elution pressure was 100 psi and concentration of each amino acid was 0.3 μM. All other conditions were the same as previously described.

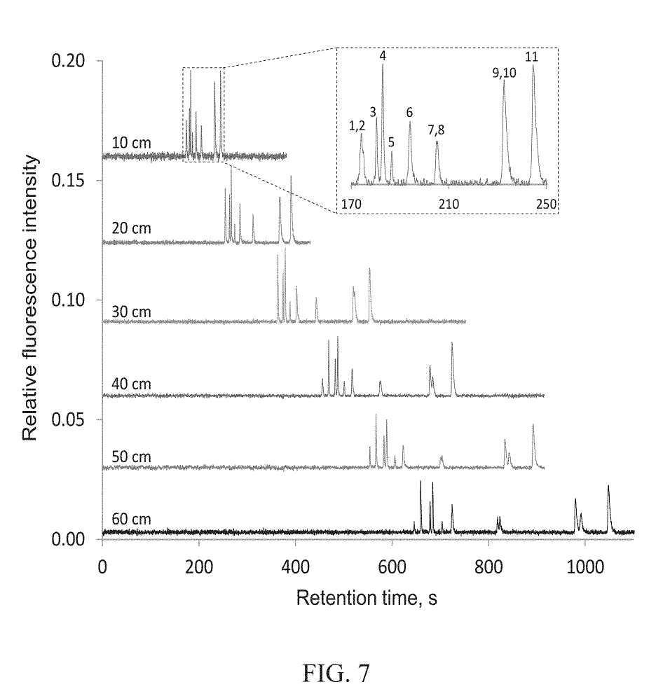

FIG. 7 shows the effect of column length on resolution. Separation column had a total length of 75 cm and an i.d. of 2 μm. The effective lengths were marked on the corresponding chromatograms. Mobile phase A was 10 mM NH₄HCO₃ in DDI water and mobile phase B was acetonitrile. Isocratic elution was carried out using 20% mobile phase B and 80% mobile phase A under an elution pressure of ca. 600 psi. Injection volume was ca. 7.1 pL. The sample contained histidine (1), asparagine (2), glycine (3), tyrosine (4), arginine (5), alanine (6), tryptophan (7), valine (8), isoleucine (9), phenylalanine (10), and leucine (11); each at 6.5 μM.

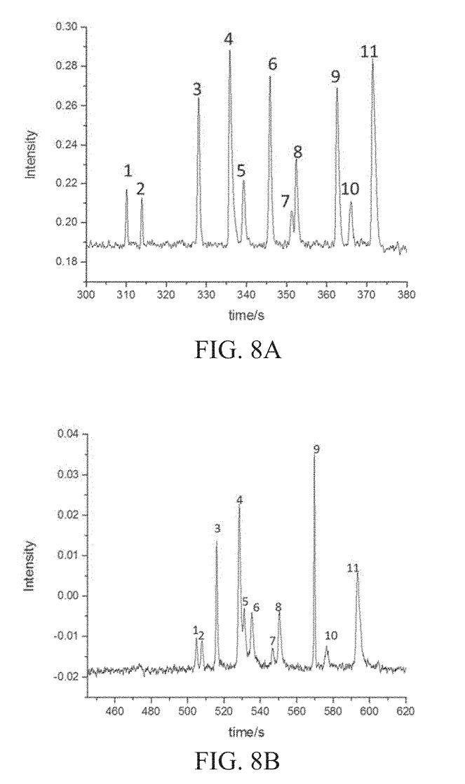

FIGS. 8A and 8B show gradient and isocratic elution results, respectively, applied to separate the 11 amino acids. Compared to the isocratic elution at 300 psi, the gradient elution made better and faster separation and all peaks were uniformly sharp as expected. Gradient elution utilized: Mobile phase A, 10 mM NH₄HCO₃ in DDI water; mobile phase B, acetonitrile. Gradient, 0-50% mobile phase B in 1.5 min, 50% B for 0.5 min then down to 0% in 3.5 min; Isocratic elution: 20% mobile phase B. Injection volume was 2 μL. Pressure on the column was about 300 psi.

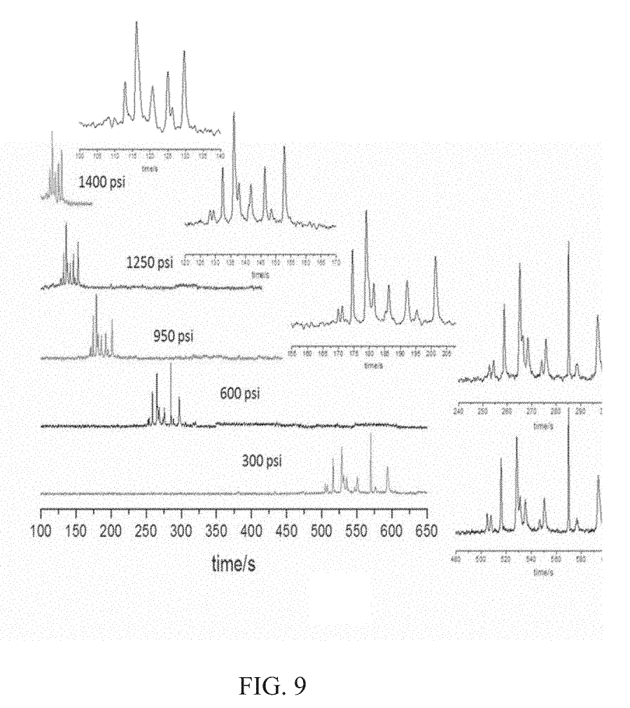

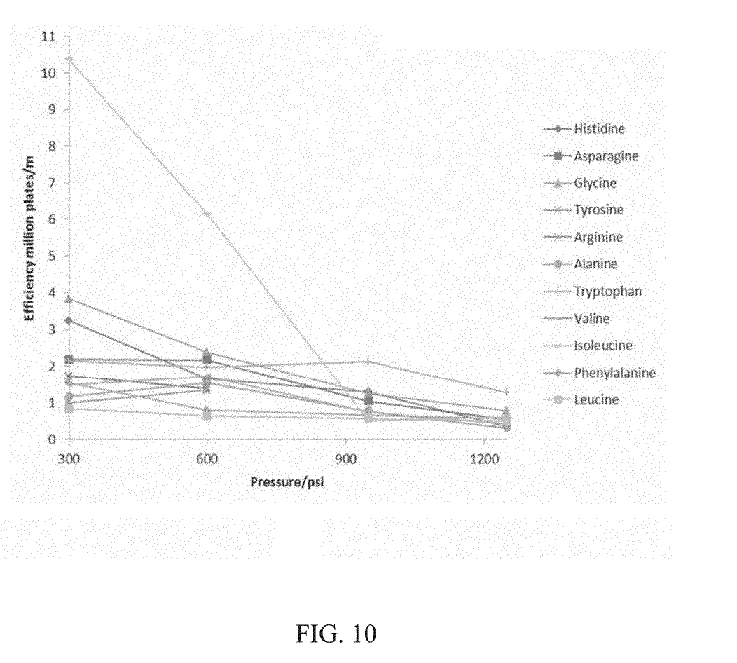

FIG. 9 presents chromatograms under different elution pressures. The zoom-in chromatograms were placed on the right accordingly. While the separation speed increased, the separation efficiencies decreased with the increasing elution pressure. We used the half height width of each peak to calculate theoretical plates per meter. At 300 psi, all 11 peaks of amino acids had efficiencies over 800,000 theoretical plates per meter, 5 of them (Histidine (1), Asparagine (2), Glycine (3), Tryptophan (7), Isoleucine (9)) had efficiencies over 2 million plates per meter, and the separation efficiency of Isoleucine reached over 10 million plates per meter in just 10 min. No efficiency result was shown for tyrosine (4), Arginine (5) at 900 psi and 1200 psi because these two peaks merged into one peak at high pressure. Even at 1250 psi when 11 peaks were eluted out in less than 2.5 min, the efficiencies of 7 peaks had more than 400,000 plates per meter. It is believed that these efficiencies are exceptionally high for fast separation and have not previously been achieved by chromatography. The change in separation efficiency at different pressures is shown graphically in FIG. 10.

### Example 2

The OTLC apparatus having the 2-μm-i.d. column was used to separate three trypsin-digested peptide samples: (1) trypsin-digested bovine serum albumin (BSA), (2) trypsin-digested myoglobin, and (3) a mixture of 1 and 2, each at 0.62 mg/mL. Elution pressure was 675 psi. All other conditions were the same as previously described.

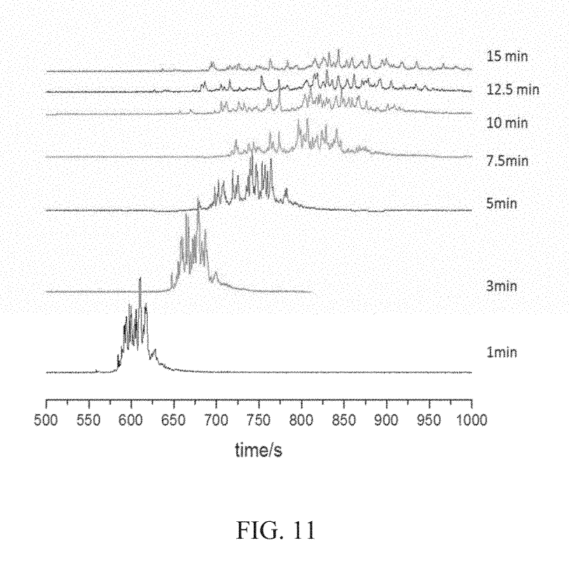

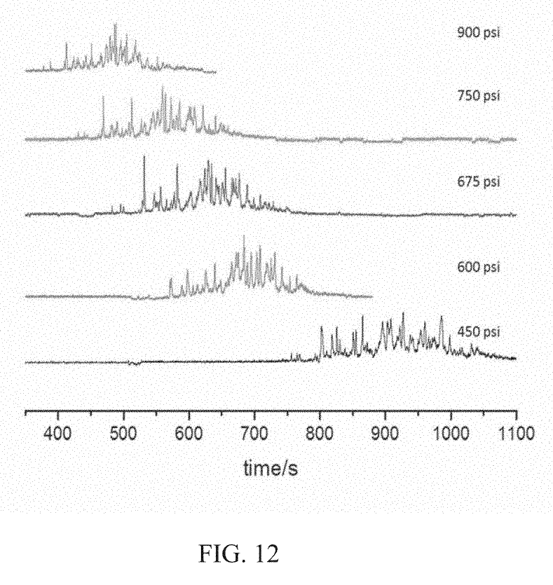

FIG. 11 shows chromatograms using different gradient times for separation of trysin-digested protein. The peak capacity increased with the gradient time. In only 15 min separation (corresponding to 10 min gradient time), about 40 peaks from trypsin digested BSA sample were obtained, which required more than 40 minutes by conventional packed column. A 10 minute gradient time was picked after compromising the time and separation efficiency. The pressure applied on the column was optimized using 10 min gradient time. 675 psi was chosen as the optimal pressure for this gradient time based on the separation shown in FIG. 12. (The separation column was of 48-cm total length and 44-cm effective length, 150-μm o.d. and 2-μm i.d. Mobile phase A, 10 mM NH₄HCO₃ in DDI water; mobile phase B, acetonitrile. Gradient, 0-82.5% mobile phase B in 10 min, injection volume, 2 μL; sample, digestion of 0.62 mg/mL BSA; pressure on the column was varied.)

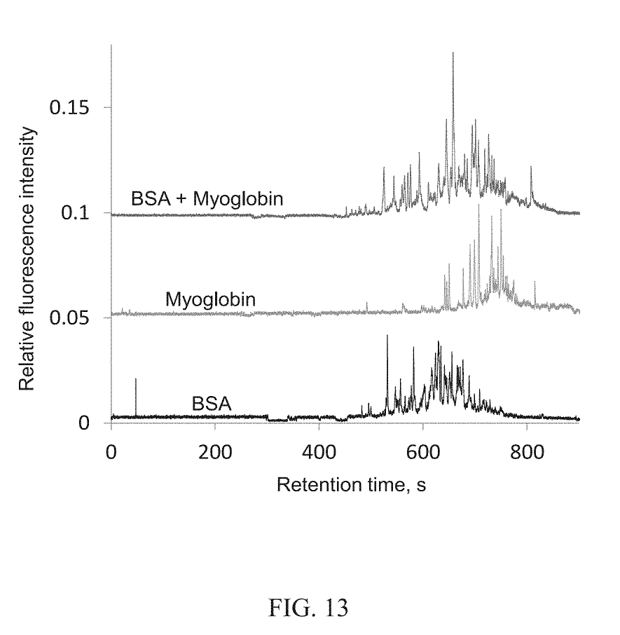

The optimized pressure and gradient were finally applied for separation of BSA and Myoglobin trypsin digest. In less than 15 min, more than 60 peaks from both digests were separated as shown in FIG. 13. A peak capacity calculation based on the average peak width 10% height ˜2 s resulted in an average value of 300 expected peak capacity, which shows a potential capacity for more complicated sample in a fast separation. The separation column was of 48-cm total length and 44-cm effective length, 150-μm o.d. and 2-μm i.d. Mobile phase A, 10 mM NH₄HCO₃ in DDI water; mobile phase B, acetonitrile. Gradient, 0-82.5% mobile phase B in 10 min, injection volume, 2 μL; sample, digestion of 0.62 mg/mL BSA; pressure on column-675 psi. BSA trypsin digest and Myoglobin trypsin digest were separated respectively, followed by the separation of mixture of both trypsin digests.

### Example 3

An OTLC for E. coli peptic/tryptic digests was prepared using the following procedures: E. coli cells were cultured using an E. coli strain ER2738 in 10% glycerol Lysogeny broth (LB) medium frozen at −80° C., and warming it at room temperature. A sterilized inoculating loop was dipped into the above solution and transfer it to a 10-ml sterilized centrifuge tube containing 5 ml LB medium and the tube was loosely capped allowing E. coli to have enough air to breath. The above E. coli solution was incubated at 37° C. for 24 h and frozen for future use.

E. coli. lysate was prepared by thawing 1 ml of frozen E. coli sample on ice for 15 min, and diluting the re-suspended pellet to 20 ml with PBS buffer. The solution was transferred to a 50-ml conical centrifuge tube, warmed at 24° C. for 30 min, and centrifuged briefly at 220 rpm (to make the solution go to the bottom). The solution was centrifuged at 10,000 g for 30 min at 24° C., and the supernatant collected.

Lysate digestion with pepsin and trypsin was performed using 1 mL of the above E. coli. lysate (the solution was estimated to contain ˜10 mg total protein/ml) and adding 5 μL 1M NaAc/HAc buffer (pH=4) and 1 μL of pepsin (1 μg/ml). The mixture was incubated at 37° C. for 1 h. Then 100 μL of the above solution was transferred to a 1.5-mL microcentrifuge tube, 900 μL of 25 mM NH₄HCO₃ and 1 μL of 1 M DTT added into above solution, and the solution was allowed to equilibrate at room temperature for at least 1 h. 10 μL of 0.2 mg/mL trypsin solution was added into above mixture, and the vial was sealed with parafilm and incubated at 37° C. for 24 h.

Fluorescence labeling was achieved by mixing 10 μL of the above digests with 10 μL of 10 mM KCN solution and 10 μL of 10 mM FQ solution in a vial. The mixture was kept in the dark at room temperature for 1 h prior to separation.

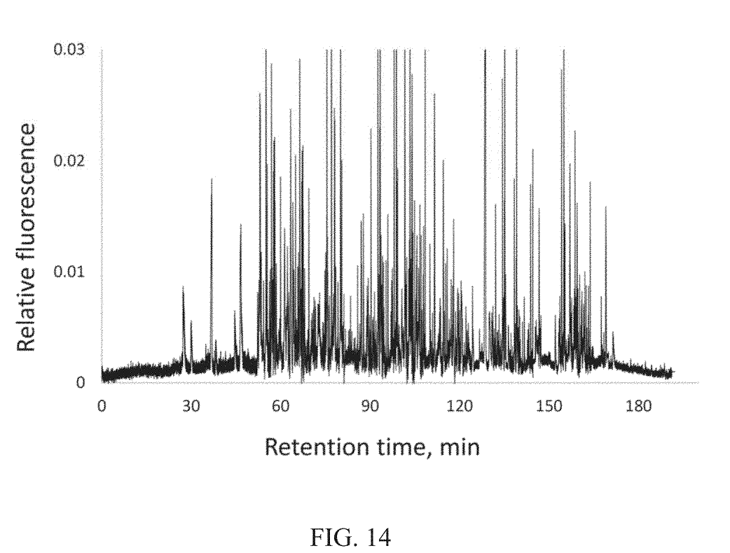

The above E. coli tryptic digests were separated using a 2-μm-i.d.×80-cm-length (75 cm effective) c18-coated OTLC column. 10 mM NH₄HCO₃ in DDI water was used as mobile phase A, and 100% acetonitrile was used as mobile phase B. The volume of sample injected was ˜160 pL, the elution pressure was ˜500 psi, and the elution rate was ˜0.2 nL/min. A linear gradient elution was programmed for ACN to increase linearly from 0% to 80% within 180 min. FIG. 14 shows a typical resulting chromatogram.

### Example 4

A 2-μm-i.d. chromatographic column was used to address analysis of protein expression in single cells. This can be particularly challenging, because protein samples are complex and protein concentrations are very low. A laser-induced fluorescence detector (LIF) was used that was capable of detecting zL solutions inside the 2-μm-i.d. capillary described in Example 1. The LIF detector has a limit of detection (LOD) of 0.8 nM and a linear dynamic range of >10³. If we assume the laser spot on the narrow capillary had a diameter of ˜50 μm, the volume of the solution illuminated was π×(1 μm)²×50 μm=1.6×10⁻²² L. That is to say, the LOD of the LIF detector was ˜70 fluorescein molecules or 12 yoctomoles (1 yoctomole=1×10⁻²⁴ mol).

To simultaneously size and quantify zepto-mole DNA at high-throughput in free solution, a pL-to-fL sample containing a few to a few hundred DNA molecules was injected into the narrow capillary column and the resolved DNA fragments were monitored by the LIF detector.

The system comprised a pressure chamber, a pL-to-fL sample injection scheme, a bare narrow open capillary column generally as described in Example 1, and the LIF detector. The narrow capillary column had an i.d. of 2 μm, an o.d. of 200 μm, and a total length of 47 cm (41-cm effective length). The restriction capillary had an i.d. of 20 μm with a length varying from 3.5 to 44 cm. The capillary connecting the injector and a microfabricated flow splitter had an i.d. of 75 μm and a length of 6 cm. The pressure applied was 360 psi, and the eluent was 10 mM tris-EDTA buffer at pH 8.0.

Because pL-to-fL injection valves are not commercially available, a 60-nL injection valve (VICI, Houston, Tex., USA) was employed in conjunction with a microfabricated flow-splitter (Chip-T) to implement the pL-to-fL sample injections. As the eluent was driven through the 60-nL injection valve to the microfabricated Chip-T, it was split into two streams: one stream went to the narrow capillary column while the other went through a restriction capillary (RC) to a waste reservoir. Since the flow resistance through the narrow capillary column was fixed, a specific flow splitting ratio was determined by selecting a specific restriction capillary via the RC selector.

First, “T” grooves were created on two glass wafers using HF etching. Because the line-width of the channel pattern on the photomask was 10 μm and HF etching was isotropic, the grooves had a semicircular profile after being etched to a depth of 190-200 μm. Round channels (with 380-400 μm diameter) were formed as the two etched wafers were face-to-face aligned and bonded. The narrow capillary column (47-cm-long, 2-μm-i.d., and 200-μm-o.d.), the capillary (6-cm-long, 100-μm-i.d., and 375-μm-o.d.) between the injector and the Chip-T, and the auxiliary capillary (AC) (15-cm-long, 100-μm-i.d., and 375-μm-o.d.) were connected to the Chip-T at positions 1, 2, and 3, respectively. Capillary-to-Chip connections were secured using epoxy adhesive. The other end of the AC was connected to an RC selector (six-position selector, also from VICI). The six restriction capillaries (RC₁-RC₆) had the same i.d. but different lengths (3.5, 6.5, 13, 22, 33, and 44 cm, respectively). As the RC selector connected AC to RC₁, RC₂, RC₃, RC₄, RC₅, and RC₆, the flow splitting-ratios were measured to be 1.05×10⁴, 1.40×10⁴, 2.14×10⁴, 3.53×10⁴, 7.06×10⁴, and 1.40×10⁵, corresponding to injection volumes of 5.7, 4.3, 2.8, 1.7, 0.85, and 0.43 pL, respectively. Using this system, we can resolve DNA from tens of base pairs to more than a hundred thousand base pairs at high throughput, and the LOD for 20 kilo base pairs of DNA was ˜8 molecules.

### Example 5

To demonstrate the use of open tubular nanocapillary chromatography (OTNC) for trace-sample analysis, the injector and flow-splitter were removed from the system as described in Example 2, and the solution vial was replaced with a nano-vial. The nanocapillary or OTNC column is dipped directly into the nano-vial to perform sample injection. The nanocapillary can be attached to a micro-T flow splitter to perform OTNC separations. To prepare a nano-vial, a piece (e.g., 10-cm-long and 300˜500-μm-i.d.) of capillary is sealed on one end of the capillary (e.g. by a torch). The capillary is cut from the sealed end to a 3˜5-mm-long segment to make a nano-vial; the full volume of the vial is 0.2˜1 μL. To optimize the OTNC column dimensions, capillaries having i.d. of 1, 2, 5, and 10 μm and lengths of 0.2, 0.5, 1, 2, 5, and 10 m can be used. The interior walls of these capillaries can be coated with the optimized protocol.

### Example 6

To illustrate optimization of OTNC for analyzing proteins/peptides in exosome samples, exosomes can be isolated from cultured Hela cells using an ultracentrifugation process. Ultracentrifugation is the conventional and most commonly used method for isolating exosomal pellets. A high g force of ˜200 000 g can be used to sediment the exosomes. If the purities and recoveries are inadequate, sucrose gradient centrifugation can improve the purity and recovery. Exosome isolations can be lysed and proteins digested. The peptides can be fluorescently labeled using an ATTO-TAG™ FQ amine-derivatization kit.

The sample preparation procedure can be optimized so we can use trace amounts of exosome isolates, for example using a volume of 10 μL containing 1 μg of protein (total). The volume can be reduced to less than 500 nL and/or the protein quantity to less than 50 ng. Capillary segments (e.g., 2-cm-long and 500-μm-i.d.) with sealed ends can be used as reaction containers. Solutions can be manipulated with our nanopipetter equipped with a pulled capillary tip (e.g., 20-μm-i.d. and 50-μm-o.d.).

The separation parameters (injection volume, gradient profile, flow rate, separation time, etc.) can be optimized to achieve a peak capacity of ˜700 in ˜2 h. These results will be superior to the best results (a peak capacity of ˜400 in >3.5 h) reported using a porous layer open tubular (PLOT) column for peptide analysis. If the column length is increased to several meters and the gradient time (t_{g}) to 2 h, it is expected that w_{0.1} will increase, but it will be less than 10 s; this represents ˜50% improvement over the state-of-the art results. Using the equation,

$$p = 1 + {t}_{g} \text{/} ( \frac{1}{n} {\sum }_{i = 1}^{n} {w}_{i} ) ,$$

where p stands for peak capacity and n is the number of peaks selected to calculate the average peak width, we estimate p≈700.

### Example 7

To illustrate OTNC separation of single cell lysates, a microchip in which round channels of two diameters (e.g., 150 μm and 20 μm) can be fabricated. The 150 μm matches the o.d. of all six incorporating capillaries and the 20 μm matches the i.d. of all capillaries but the OTNC column. The OTNC capillary can have an i.d. of 1-2 μm, and can be connected to the microchip at position 4. A small pocket (e.g., ϕ20 μm×20 μm) can be formed above the inlet of the OTNC column. A microscope can be employed to watch the channel cross region on the microchip. Cells can be delivered via a six-port valve to the microchip. After a single cell is settled into the small pocket, a high electric field or detergent solution can be delivered via capillaries at positions a and b to lyse the cell. Then, capillaries at positions 1, 2, a and b will be blocked via external valves (e.g. by switching the six-port valve to another position, capillaries at positions 1 and 2 are blocked) and the HPLC pump (likely with a flow splitter) will be turned on to perform sample injection. The sample injected into the OTNC column depends on the injection time and the pressure drop across the column. After capillaries at positions a and b are unblocked and cellular debris is flushed out, these capillaries can be blocked again to perform an OTNC separation. A LIF detector can be used to monitor the separation.

Acute myloid leukemia (AML) suspension cells labeled with calcein AM can be used for example. Calcein AM is a cell permeable molecule cleaved by esterases upon entering the cell resulting in a negatively-charged fluorophore incapable of passively diffusing across the cell membrane.

A risk in using this system is that cellular debris can adhere to channel walls, which may lead to blocked channels/capillaries. Channels/capillaries can be coated in one embodiment with polyacrylamide or poly(vinyl alcohol), adding pluronic P84 in the flushing solution and/or optimizing the flushing conditions to get rid of the cellular debris. The chip can be designed to deliver a washing solution (e.g., allowing a liquid jet to rinse the small pocket) to eliminate the debris.

It will be understood from the foregoing examples and descriptions that various modifications and changes may be made in the various embodiments of the present disclosure without departing from their true spirit. The description provided herein is intended for purposes of illustration only and is not intended to be construed in a limiting sense. Thus, while the presently disclosed inventive concepts have been described herein in connection with certain embodiments so that aspects thereof may be more fully understood and appreciated, it is not intended that the presently disclosed inventive concepts be limited to these particular embodiments. On the contrary, it is intended that all alternatives, modifications and equivalents are included within the scope of the presently disclosed inventive concepts as defined herein. Thus the examples described above, which include particular embodiments, will serve to illustrate the practice of the presently disclosed inventive concepts, it being understood that the particulars shown are by way of example and for purposes of illustrative discussion of particular embodiments of the presently disclosed inventive concepts only and are presented in the cause of providing what is believed to be a useful and readily understood description of procedures as well as of the principles and conceptual aspects of the inventive concepts. Changes may be made in the devices and methods described herein without departing from the spirit and scope of the presently disclosed inventive concepts. The claims listed herein are not intended to limit the claims which may be filed in subsequent applications which claim priority to the present application.

What is claimed is:

1. An open tubular liquid chromatography apparatus, comprising:
a liquid chromatography capillary having an inner surface and an inner diameter in a range of about 1 μm to about 5 μm, the inner surface coated with a stationary phase film;
a valve in fluid communication with the liquid chromatography capillary for adding a sample to the liquid chromatography capillary;
an injector in fluid communication with the valve for driving liquid eluent through the liquid chromatography capillary whereby components of the sample are separated in the eluent; and
one or more detector(s) for detecting the components in the sample as the components elute from the liquid chromatography capillary.

2. The open tubular liquid chromatography apparatus of claim 1, wherein the inner diameter of the liquid chromatography capillary is in a range of 1 μm to 3 μm.

3. The open tubular liquid chromatography apparatus of claim 1, wherein the inner diameter of the liquid chromatography capillary is in a range of 1 μm to 2 μm.

4. The open tubular liquid chromatography apparatus of claim 1, having an efficiency in excess of 10⁶ plates/m.

5. The open tubular liquid chromatography apparatus of claim 1, wherein the stationary phase film comprises alkyl-containing molecules chemically grafted to the inner surface.

6. The open tubular liquid chromatography apparatus of claim 1, wherein stationary phase film comprises carbon chains having 2-18 carbons.

7. The open tubular liquid chromatography apparatus of claim 1, wherein the stationary phase film comprises an organic selected from organosilanes, polyvinyl benzenes, polystyrenes, and combinations thereof.

8. The open tubular liquid chromatography apparatus of claim 1, wherein the stationary phase film comprises an organosilane.

9. The open tubular liquid chromatography apparatus of claim 1, wherein the valve comprises a microchip and at least a portion of the liquid chromatography capillary is disposed in a channel in the microchip.

10. The open tubular liquid chromatography apparatus of claim 1, wherein the injector drives the liquid eluent by electroosmotic flow.

11. The open tubular liquid chromatography apparatus of claim 1, wherein the injector is a pressure pump, a gradient pump, or an electrical pump.

12. The open tubular liquid chromatography apparatus of claim 1, wherein the injector drives the liquid eluent at a pressure greater than 100 psi.

13. The open tubular liquid chromatography apparatus of claim 1, wherein the one or more detector(s) comprises a laser-induced fluorescence detector.

14. The open tubular liquid chromatography apparatus of claim 1, wherein the one or more detector(s) comprises a mass spectrometer.

15. The open tubular liquid chromatography apparatus of claim 1, wherein the one or more detectors comprise multiple detectors in series.

16. A method for analyzing a sample, comprising:
providing an open tubular liquid chromatography apparatus comprising at least one liquid chromatography capillary having an inner surface and an inner diameter in a range of 1 μm to 5 μm, the inner surface coated with a polymer film;
injecting the sample into the at least one capillary tube and causing the sample to be driven therethrough, wherein the sample is separated into components;
eluting the sample; and
analyzing the components of the eluted sample with laser-induced fluorescence detection.

17. The method of claim 16, wherein the inner diameter of the liquid chromatography capillary is about 1 μm to about 3 μm.

18. The method of claim 16, wherein the inner diameter of the liquid chromatography capillary is about 1 μm to about 2 μm.

19. The method of claim 16, wherein the polymer film is chemically grafted to the liquid chromatography capillary inner surface and comprises alkyl-containing molecules with a chain length of 2 to 18 carbons.

20. The method of claim 16, wherein the polymer film on the liquid chromatography capillary inner surface comprises an organic selected from organosilanes, polyvinyl benzenes, polystyrenes, and combinations thereof.
